(19) United States
(12) Patent Application Publication
(10) Pub. No.: US 2015/0367545 A1
(43) Pub. Date: Dec. 24, 2015

(54) ZERO DRAFT MOLD

(71) Applicant: APPLE INC., Cupertino, CA (US)

(72) Inventors: Bruce E. Berg, Cupertino, CA (US); Christopher J. Stringer, Cupertino, CA (US); Glenn Aune, Cupertino, CA (US); Ryan P. Brooks, Cupertino, CA (US)

(21) Appl. No.: 14/311,330

(22) Filed: Jun. 22, 2014

(51) Int. Cl. B29C 45/26; B29C 33/76; B29C 45/36

(52) U.S. Cl. CPC B29C 45/261; B29C 45/36; B29C 33/76; B29K 2905/00; B29L 2031/7544

(57) ABSTRACT

An article for use in an injection molding process is disclosed. The article is a sleeve which may be used to facilitate the removal of a molded part from a central core. The device eliminates the need for a draft angle which may be unsuitable for molded parts in certain applications. A method for injection molding is disclosed which uses this sleeve in the injection molding process. An article produced by this process is also disclosed.

### TECHNICAL FIELD

The described embodiments relate generally to injection molding. More particularly, the present embodiments relate to a mold device and method for eliminating draft angle in an injection molded article.

### BACKGROUND

Injection molding is a widely used method of manufacturing plastic parts for modern devices, such as portable electronic devices. Injection molding techniques can produce high volumes of the same object in a cost effective manner. Injection molding forces molten plastic material into a mold cavity. The plastic material solidifies into a shape that has conformed to the contour of the mold. Thermoplastic and thermosetting polymers are widely used as the injected plastic material. Thermoplastics generally are preferred because they are more versatile allowing them to have wider application.

Various processes are involved in an injection molding manufacturing system. One portion of the molding process that has proved challenging in the past relates to the removal of molded article from the mold. The plastic molded part may adhere to the mold and thus be difficult to remove or be damaged during the process of removal. Such damage to the molded article may be unavoidable due to the nature of the injection molding process. To eliminate these defects, large increases in design and fabrication cost would be required. One particular type of objectionable characteristic of a molded article resulting from the injection molding process is caused by a draft angle or distance which is a generally known characteristic in the injection molding art.

The draft on a part may, in some cases, provide sufficient taper to aid in their removal from of an injection molded part from a mold or core. For example, a hollow plastic box may be molded as an open five-sided shape. Once the plastic has hardened around the mold, the mold must be removed. The plastic may contract slightly during the hardening process making separation from the mold more difficult. By tapering the sides of the mold by an appropriate “draft angle” the mold will be easier to remove. The draft angle issue may become more pronounced if the molded article has internal walls. For example, a draft angle of 1 degree may be sufficient for the external walls of a molded article, a draft angle of up to 5 degrees may be required on interior walls of the molded article due to shrinkage and possible molded part warping.

Today, the term stylus generally refers to an input tool used with Personal Digital Assistants (PDAs), graphics tablets, Tablet Personal Computers (PC's), and Ultra Mobile Personal Computers (UMPCs). Modern day styli generally take the shape of a writing instrument, such as a pen, and are made to comfortably fit in the grip of a user's hand. These styli can be found in all different sizes and shapes.

In many electronic device applications, the user operates a touchscreen with a stylus, rather than using a finger in order to avoid getting the natural oil from the user's hands on the screen. Use of a stylus also improves the precision of the touch input, allowing use of smaller user interface elements. Styli may also be used for handwriting or drawing on a touch-sensitive surface such as a computer tablet screen and may assist a user to accurately navigate through menus, send messages etc. Modern styli may have a hollow interior to contain various electronic devices or other components. For example, some types of styli may contain additional devices such as illumination devices, microphones, or other components. For these reasons, it may be desirable to have a stylus with a hollow interior cavity which is uniform and does not contain a draft angle as a result of the injection molding process as described above.

### SUMMARY

A method and device is disclosed which allows for a draft free injection molding process. That is, the requirement for a draft angle or dimension as is required with conventional injection molding processes is eliminated by using a flexible sleeve during the injection molding process. The flexible sleeve may be made from a low friction metal material and has a slot running along its entire length. A core is employed with the sleeve and the core has a key or rib extending the length of the core. The key fits into the slot on the sleeve such that the sleeve may fit onto the core and be retained thereon. This assembly, in one embodiment, defines a substantially circular outer surface.

In the method, the sleeve/core assembly is placed into a mold and plastic is injected into the cavity defined by the void between the sleeve and the mold. After curing, the molded article and the assembly are separated from the mold and the molded article along with the sleeve are separated from the core by sliding the sleeve off of the core. Because the sleeve is made of metallic or another low friction material it slides off of the core relatively easily. Once the core is removed from inside of the sleeve, the inherent flexibility of the sleeve material along with the slot running along its length causes the sleeve to bias inwardly making its removal from the inside of the molded article easy and eliminating damage to the inner surface of the molded article that could otherwise be caused by removal of the molded article from the core if no draft angle was included. As discussed herein, there are applications for molded articles such as a small diameter stylus in which the inclusion of a draft angle would make the resultant molded article unsuitable for its intended purpose as a stylus.

The use of the embodiments disclosed herein allow for the use of injection molding to produce molded parts which have various uses. As mentioned, a stylus for use with an electronic device is one such use. There may also be medical or other applications for the molded articles produced through use of these embodiments. In addition, because no special mold separation devices or methods are required, shorter cycle times, higher productivity and lower cost per molded article may result.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a side view of a conventional injection molding machine;

FIG. 2 shows a side view of a conventional injected molded article illustrating a draft angle;

FIG. 3 is a perspective view of a sleeve in accordance with one embodiment;

FIG. 4 is an end view of the sleeve of FIG. 3;

FIG. 5 is a perspective view of a core in accordance with one embodiment;

FIG. 6 is an end view of the core of FIG. 5;

FIG. 7 is a side view of a core mounted on a base;

FIG. 8 is a side view of the core of FIG. 7 with a sleeve thereon;

FIG. 9 shows the assembly of FIG. 8 in a mold;

FIG. 10 is a side view of the assembly of FIG. 8 with a molded article thereon;

FIG. 11 is an end view of the assembly of FIG. 8 with a molded article thereon;

FIG. 12 is an end view of the molded article with the core removed;

FIG. 13 is a perspective view illustrating an alternate sleeve configuration; and

FIG. 14 is a flow chart of an injection molding process in accordance with one disclosed embodiment.

### DETAILED DESCRIPTION

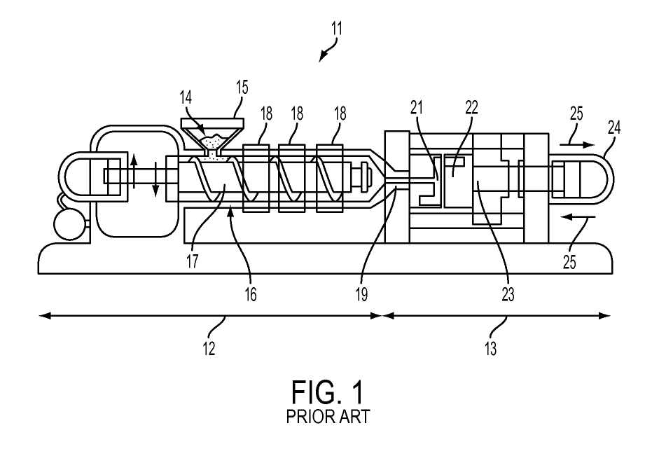

Reference will now be made in detail to representative embodiments illustrated in the accompanying drawings and in particular with reference to FIGS. 1-14. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims. Those skilled in the art will readily appreciate that the detailed description given herein with respect to these Figures is for explanatory purposes only and should not be construed as limiting.

Referring to FIG. 1, a perspective view of a conventional injection molding machine 11 is shown. In particular, molding machine 11 includes an injection portion 12 and a clamping portion 13. In injection portion 12 a plurality of plastic granules 14 are placed into a hopper 15. Granules 14 drop into a barrel portion 16 where they are fed by a reciprocating screw 17 through a heater 18 where they are melted. The resultant molten plastic material is fed through nozzle portion 19 into a mold cavity 21 defined by a mold 22. A moveable platen 23 may be moved by a press 24 in the direction of arrows 25 both toward and away from mold 22 such that platen 23 holds mold 22 in place while plastic material is fed into mold 22. In this way an injection molded article may be formed.

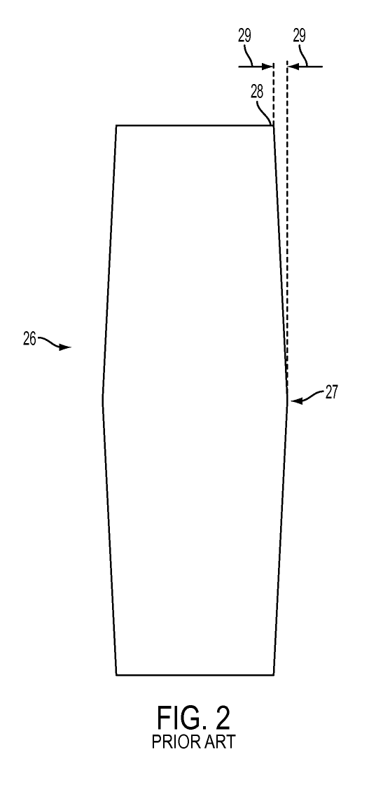

Referring to FIG. 2, an injection molded cylindrical article 26 is shown in side view. This figure illustrates that cylindrical article 26 is not perfectly cylindrical. Because of the required “draft” for removing the injection molded article from a mold, there is a taper in the cylindrical article. The amount of the taper in this example is approximately 2 degrees from the midpoint 27 to the end point 28 of molded article 26. This taper amount is illustrated by arrows 29 which show the offset or taper amount. This taper or offset is generally known as “draft” angle or draft dimension which facilitates removal of the molded article from the mold as described above. While a two degree draft angle may be suitable for external surfaces, larger draft angles up to 5 degrees or more may be required for internal surfaces of injection molded articles such as for a central hollow core of a cylindrical tube.

While, for certain injection molded articles, a draft angle may be acceptable, there are other applications where precise dimensions are important and a draft angle is unacceptable. For example, in the case of a stylus for use with various electronic devices, it is important that the interior of the stylus be as close to a perfectly cylindrical opening as possible in order that certain electronic components and other devices may be included within the stylus. In one implementation, the stylus dimension may be approximately 180 mm in length and 6 mm in diameter, (an aspect ratio of 30:1). A 1 degree draft angle results in approximately a 3.1 mm variation from the center line of the hollow core to each side of the internal wall end to end (180 mm times the tangent of 1 degrees [0.0175]) or 6.3 mm core diameter variation end to end. That is, one end would have a core diameter of 6 mm while the other end would be over 12 mm. This may greater than the diameter of the article itself depending upon wall thickness. Alternatively, if a maximum core diameter of 6 mm is required then the other end of the core would have no opening. In other words, the article would be unacceptable or un-manufacturable with a 1 degree draft angle. Even if the draft calculation was done from midpoint 27 as shown in FIG. 2, a 1 degree draft angle results in an end diameter of the cylindrical opening of less than 3 mm or greater than 9 mm and this type of midpoint draft complicates the molding process because the center shaft would need to be removed in 2 pieces—one from each side.

As stated above, for internal surfaces, draft angles of up to 5 degrees are not uncommon which would make using a draft angle in the manufacturing process unsuitable for a stylus with dimensions as described above. If the aspect ratio was about 10:1 or a 180 mm length with an 18 mm diameter, using a 1 degree draft angle results in a variation of diameter of about 12 mm to 24 mm in the molded article. While not preferred, this variation may be acceptable in some applications. For the article with a 30:1 aspect ratio described above, the resulting molded article including a 1 degree draft angle would be unsuitable for its intended use as a stylus containing various electronic or other components. In general, for molded articles with high aspect ratios (above 10:1) the use of draft angles becomes extremely problematic. Using the mold and process disclosed herein permits the molding of these high aspect articles without unacceptable variations due to draft angles. If draft angles more than 1 degree are required, molded articles with aspect ratios less than 10:1 may advantageously use the disclosed mold and process.

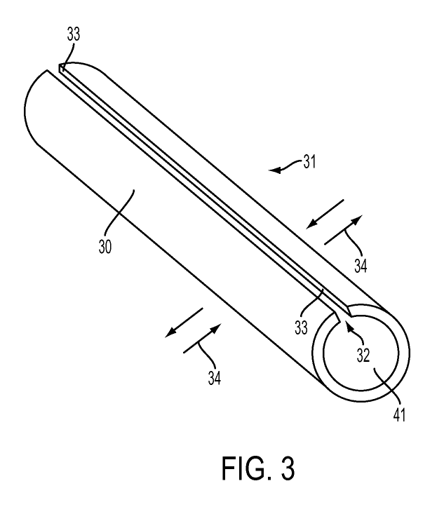

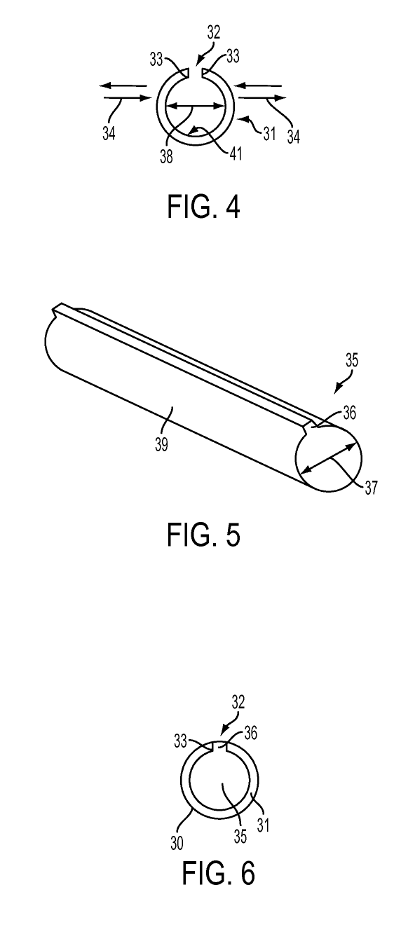

Referring to FIG. 3, a cylindrical sleeve 31 is shown in perspective view. Cylindrical sleeve 31 may include a slot portion 32 which runs along the entire length of sleeve 31. Slot portion 32 allows edges 33 on sleeve 31 to articulate toward and away from one another as shown by arrows 34. In one embodiment, cylindrical sleeve 31 may be used in an injection molding process for a cylindrical stylus to eliminate a draft angle as will be described herein. Cylindrical sleeve 31 also includes, in one embodiment, a smooth outside surface 30. Referring to FIG. 4, an end view of cylindrical sleeve 31 is shown. Slot portion 32 is shown between edges 33 which may move toward and away from one another in the direction shown by arrows 34 according to the flexibility of the material comprising sleeve 31. In one embodiment, sleeve 31 may be comprised of a polished metal material with low frictional surfaces which is also suitable for withstanding injection molding process temperatures and pressures.

Referring to FIG. 5, a core cylindrical portion 35 is shown in perspective. Cylindrical portion 35 may be a solid material or may include hollow center portion without departing from the scope of the described embodiments. Cylindrical portion 35 has a key portion 36 running the entire length of cylindrical portion 35. Cylindrical portion 35 may be made from any suitable material which is able to withstand the injection molding process temperatures and pressures. Cylindrical core 35 has an outside diameter 37 which is approximately equal to the inside diameter 38 of sleeve 31 such that an outside surface 39 of core 35 contacts an inner surface 41 of sleeve 31. Core 35 may thus fit inside sleeve 31 and apply pressure to the inside walls 41 of sleeve 31 to keep edges 33 slightly separated. Key portion 36 of core 35 is configured in both size and shape to fit into Slot portion 32 of sleeve 31 to contact edges 33 so as to force edges 33 away from one another and thus slightly bias the flexible material comprising sleeve 31. That is, the flexibility of the metal material comprising sleeve 31 causes inner surface 41 to remain in frictional contact with outer surface 39 of core 35.

Referring to FIG. 6, an end view of core 35 inserted into sleeve 31 is shown such that the exterior surface 39 of core 35 is in slidable contact with the interior surface 41 of sleeve 31. Similarly, key portion 36 on core 35 is slidably inserted into slot portion 32 of sleeve 31 such that exterior surface 30 of sleeve 31 and key portion 36 cooperate to form an assembly with a substantially circularly shaped exterior surface 30. While a circular shape is preferred in the disclosed embodiment, it can be appreciated that square, oval or other geometric shapes defined by the exterior surface of sleeve 31 and key portion 36 may be advantageously employed without departing from the scope of the claimed embodiments. The thickness of the walls of sleeve 31, that is the material between inner surface 41 and outer surface 30 of sleeve 31 may, in one embodiment be approximately 0.5 millimeters. This thickness could vary such that the walls may be thicker or thinner without departing from the scope of the described embodiments.

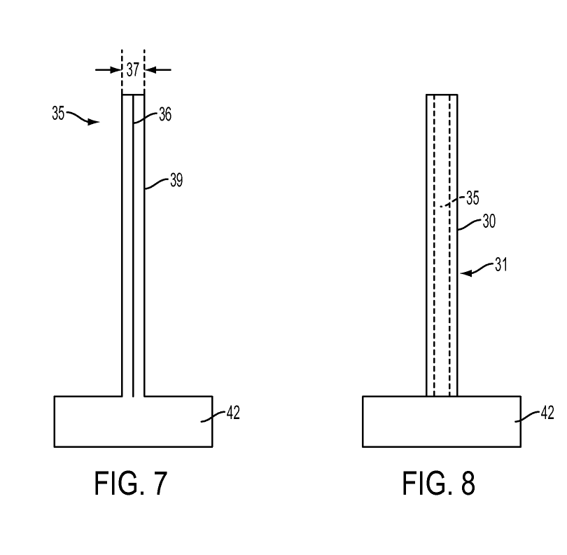

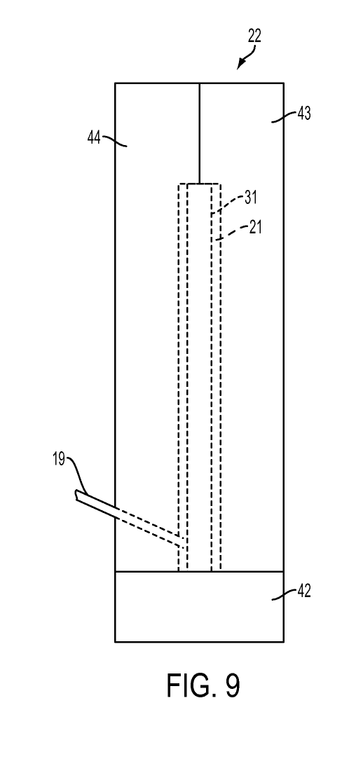

Referring to FIG. 7, core 35 is shown attached to a base portion 42 for use in an injection molding machine such as that shown in FIG. 1. Key portion 36 is a rib extending along the length of the exterior surface 39 of core 35. Referring to FIG. 8, sleeve 31 is shown inserted over core 35 on base 42. Exterior surface 30 of sleeve 31 and key portion 36 of core 35 form a substantially circular exterior surface such as that shown in FIG. 6. Referring to FIG. 9, the assembly of FIG. 8 is shown in mold 22. That is, first half 43 and second half 44 of mold 22 enclose sleeve 31 which in turn encloses core 35. First half 43 and second half 44 are spaced from sleeve 31 so as to form a void 21 which defines a mold cavity between the walls of first half 43 and second half 44 such that molten plastic material 14 may be injected through nozzle 19 into mold cavity 21 in an injection molding process as described above. Upon cooling of the plastic material injected into mold cavity 21, first half 43 and second half 44 are separated and the resulting molded article which was formed in mold cavity 21 may be removed as will be described below.

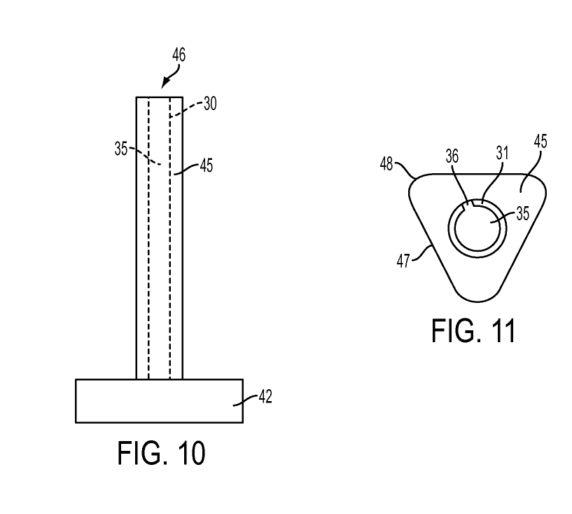

Referring to FIG. 10, a view of the assembly of FIG. 8 is shown with a molded article 45 shown on sleeve 30 which is in turn on core 35. This can be more clearly seen in FIG. 11 which is an end view of FIG. 10 looking along the direction of arrow 46 in FIG. 10. Referring to FIG. 11, molded article 45 is shown on sleeve 31 which is, in turn on core 35. Key 36 on core 35 is also shown in contact with molded article 45. In this embodiment, molded article 45 has an exterior surface 47 which may be substantially triangular with rounded edges 48 as shown. This configuration of exterior surface 47 is determined by the shape of mold cavity 21 as determined by the interior surfaces of first half 43 and second half 44 in cooperation with the external surface 30 of sleeve 31 which forms a circular perimeter surface in combination with key 36 as described above. In this embodiment, resultant molded article 45 is consistent with a stylus for use with an electronic device. It should be appreciated, however, that external surface 47, 48 of molded article 45 could take a wide variety of shapes without departing from the scope of the embodiments described herein.

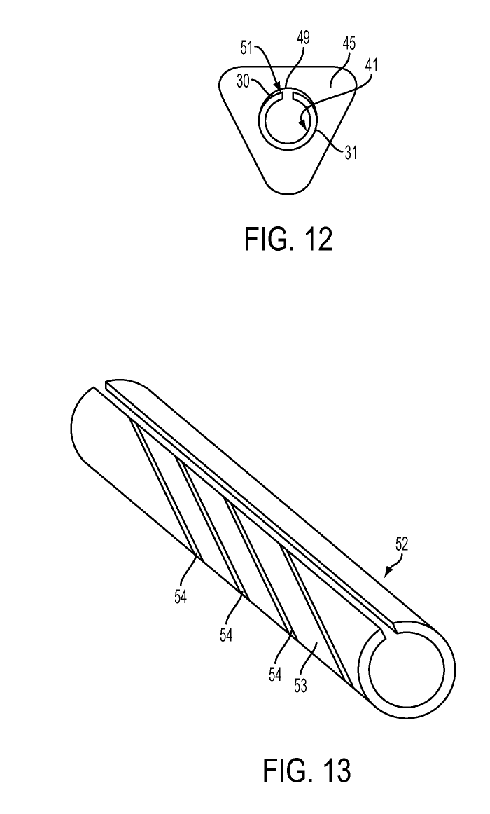

Referring to FIG. 12, an end view as described in FIG. 11 is shown with core 35 removed. As described above, sleeve 31 is, in one embodiment, made from a metal material which may be only 0.5 mm thick such that the circular walls of sleeve 31 can flex in the directions 34 shown and described with respect to FIGS. 3 and 4 above. That is, once core 35 has been removed and the internal surface 41 of sleeve 31 is no longer in contact with the external surface 39 of core 35 and key 36 is no longer separating edge surfaces 33 on sleeve 31, sleeve 31 flexes slightly inwardly to generate a gap 51 between at least a portion of outer surface 30 of sleeve 31 and an inner surface 49 of molded article 45. Gap 51 facilitates the removal of sleeve 31 from article 45. That is, smooth outer surface 30 of sleeve 31 in combination with gap 51 allows sleeve 31 to be slidably removed from part 45 without damage to the inner surface 49 of part 45. The result is that the inner surface 49 may be substantially circular along the entire length of molded article 45 because no draft angle is required to facilitate the removal of molded article 45 from core 35 as would otherwise be required if sleeve 31 were not utilized.

While the above description has been made with respect to the use of molded article 45 as a stylus, it can be readily appreciated that other uses for a tubular molded article 45 may be found. For example, a catheter or syringe for use in the medical arts may advantageously employ the embodiments described herein. By eliminating the need for a draft angle, injection molded articles may be manufactured with more precision having tighter tolerances. Additionally, while the embodiments described herein contemplate a smooth inner surface 49 in molded article 45 corresponding to smooth outer surface 30 of sleeve 31, it can be appreciated that textured surfaces may be achieved through the use of these embodiments. These textured surfaces could be for decorative or aesthetic purposes or they may be included for other utilitarian purposes.

Referring to FIG. 13, a sleeve 52 is shown in perspective view. Sleeve 52 is similar to sleeve 31 shown and described in FIG. 3. However, an external surface 53 of sleeve 52 includes lands 54 in a spiral configuration. As can be appreciated by one skilled in the injection molding art, the use of sleeve 52 would result in a spirally grooved inner surface of an injection molded article where sleeve 52 is employed in the manner described above with respect to sleeve 31. Other embodiments could include spiral grooves cut into the surface 30 of sleeve 31 instead of lands 54 such that protruding spiral lands would result on the inner surface 49 of the injection molded article 45 when that sleeve configuration was used in the injection molding process. Other exterior surface features including bumps, fins, ribs and the like may be included on surface 30 of sleeve 31 without departing from the claimed embodiments.

Because of the molding embodiments disclosed herein using flexible sleeve 52, the removal of the resultant molded article 45 from sleeve 31 and core 35 can be achieved with relative ease and without damage to the interior surface 49 of molded article 45. That is, as sleeve 52 is allowed to flex away from inner surface 49 of molded article 45, the resultant lands also pull away from inner surface 49 of molded article 45 to make removal of sleeve 52 from inner surface 49 relatively easy. The use of low friction material as the composition of sleeve 52 also contributes to making the removal process achievable without damage to the inner surface 49 of molded article 45.

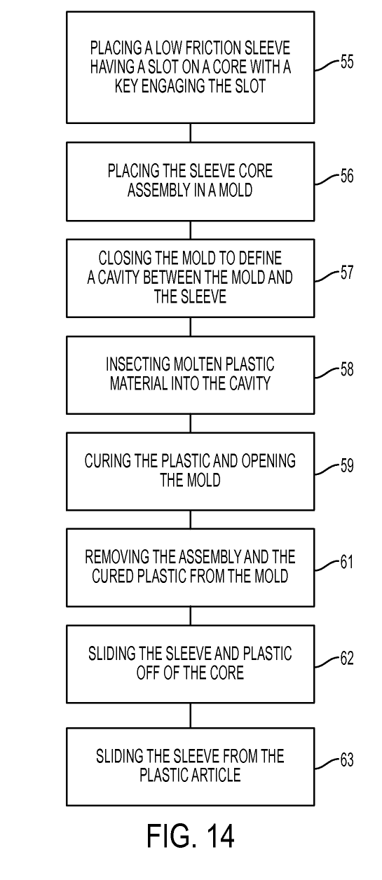

Referring to FIG. 14, a flow chart of a method for injection molding an article is described. In step 55 a low friction sleeve with a slot running along its longitudinal dimension is placed on a core which has a key extending along its longitudinal length and sized and shaped to fit into the slot on the sleeve. In step 56 the sleeve/core assembly from step 55 is then placed in a mold as in a conventional molding process. The mold is then closed in step 57 to thereby define a mold cavity between the mold surface and the sleeve surface. Molten thermal plastic is injected into the mold cavity in step 58 as with a conventional injection molding process. The plastic is allowed to cure and the mold is then opened in step 59 and the assembly and molded plastic article are removed in step 61. The molded plastic article and sleeve are slidably removed from the core in step 62. Upon removal of the core, the flexible nature of the sleeve material allows it to flex inwardly such that the sleeve may be removed from the molded plastic article in step 63 without damaging the molded plastic article. The molded plastic article thus contains an inner surface which does not include a draft angle or dimension as would otherwise be required if the slotted sleeve had not been employed during the injection molding process.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A device for use in an injection molding process comprising:
a hollow cylindrical sleeve including:
an outer surface;
a substantially smooth inner surface having a first diameter;
a slot opening from said outer surface to said inner surface extending along a length of said sleeve;
a cylindrical core including:
an outer surface having a diameter configured to engage with said first diameter; and
a key on said outer surface extending along a length of said core,
whereby said inner surface of said sleeve fits onto said outer surface of said core and said key fits into said slot such that said key and said outer surface of said sleeve define a substantially circular exterior surface.

2. The device of claim 1 wherein said sleeve comprises a metal material.

3. The device of claim 1 wherein said outer surface of said sleeve is substantially smooth.

4. The device of claim 1 wherein said outer surface of said sleeve includes a spiral rib portion extending therefrom.

5. The device of claim 1 wherein said outer surface of said sleeve includes a spiral groove in said outer surface.

6. The device of claim 1 wherein said outer surface of said sleeve includes variations extending above or below said outer surface such that said outer surface is uneven.

7. The device of claim 1 wherein said key has a profile shape substantially identical to a profile shape of said slot.

8. A method for molding an article comprising the steps of:
placing a hollow cylindrical sleeve having an inner and outer surface and including a slot extending along the length of said sleeve onto an exterior surface of a cylindrical core, said core including a key extending along the length of said core, such that said key engages said slot;
inserting the sleeve and core into an injection mold;
closing the injection mold such that a cavity is defined between said mold and said outer surface of said sleeve;
injecting molten plastic into said cavity;
curing said molten plastic;
opening said mold;
slidably removing the cured plastic and sleeve from said core; and
removing said sleeve from said cured plastic.

9. The method of claim 8 wherein said sleeve and said core define a substantially circular exterior surface.

10. The method of claim 8 wherein said sleeve comprises a metal material.

11. The method of claim 8 wherein said outer surface of said sleeve is substantially smooth.

12. The method of claim 8 wherein said outer surface of said sleeve includes a spiral rib portion extending therefrom.

13. The method of claim 8 wherein said outer surface of said sleeve includes a spiral groove in said outer surface.

14. The method of claim 8 wherein said key has a profile shape substantially identical to a profile shape of said slot.

15. The method of claim wherein said outer surface of said sleeve includes variations extending above or below said outer surface such that said outer surface is uneven.

16. The method of claim 8 wherein said article is a syringe.

17. An injection molded article comprising:
a cylindrical tube having an wall defining a hollow center portion;
said wall including an outer surface and an inner surface;
said inner surface being substantially parallel with said outer surface such that said wall includes a uniform thickness;
said wall comprising thermoplastic material; and
said cylindrical tube molded in an injection molding process whereby a cylindrical sleeve is slidably engaged with a cylindrical core portion to define said hollow center portion, said cylindrical sleeve including a slot along its length slidably engaged with a key portion on the length of said core.

18. The injection molded article of claim 17 wherein said hollow center portion comprises a substantially circular surface along the length of said tube.

19. The injection molded article of claim 17 wherein said article is a stylus for use with an electronic device.

20. The injection molded article of claim 17 wherein said sleeve includes a substantially smooth inner surface slidably engaged with said core.
